(19) United States
(12) Patent Application Publication
(10) Pub. No.: US 2026/0278154 A1
(43) Pub. Date: Sep. 17, 2026

(54) CONTROLLING PROTECTED DATA ACCESS FROM THIRD-PARTY WEB SERVER

(71) Applicant: EQUIFAX INC., Atlanta, GA (US)

(72) Inventors: Mark Di Meglio, Atlanta, GA (US); Ashish Sharma, Suwanee, GA (US); Mobashar Malik, Alpharetta, GA (US); Jayakumar Mandapati, Alpharetta, GA (US)

(21) Appl. No.: 19/565,992

(22) Filed: Mar. 13, 2026

Related U.S. Application Data
(60) Provisional application No. 63/771,328, filed on Mar. 13, 2025.

(51) Int. Cl. G06F 21/62; G06F 21/31; G06F 21/60

(52) U.S. Cl. CPC G06F 21/6245; G06F 21/31; G06F 21/604

(57) ABSTRACT

An access management server can unlock or unfreeze access to data about a user by third parties without requiring the user to navigate completely away from a third-party website through which the user is executing an electronic transaction. The access management server processes a request for a user interface for unlocking or unfreezing data about a user and stores information about the user in a cache based on determining that the data about the user is locked. The access management server transmits the user interface for display simultaneously with the third-party website. The access management server further processes an unlock request for unlocking or unfreezing the data about the user based on information provided via the user interface and based on the information of the user matches the cache. The access management server further processes a data access request for accessing unlocked data about the user.

### CROSS-REFERENCE TO RELATED APPLICATIONS

The present application claims the benefit and priority of U.S. Provisional Application No. 63/771,328, filed Mar. 13, 2025, entitled “CONTROLLING PROTECTED DATA ACCESS FROM THIRD-PARTY WEB SERVER,” the entire contents of which is incorporated herein by reference for all purposes.

### TECHNICAL FIELD

This disclosure relates generally to online data access control. More specifically, but not by way of limitation, this disclosure relates to providing access and control for unlocking or unfreezing access to data by third parties.

### BACKGROUND

Online activities or transactions can involve data or decisioning from secured data sources. Data from those secured sources can be locked or frozen such that the data is inaccessible to another party without the person or entity to which the data relates unlocking or unfreezing the data to allow access. This can require the person or entity to access the data source, provide instructions to unlock or unfreeze, and then return to the third party to complete the online activities.

### SUMMARY

Various embodiments of the present disclosure provide unlocking or unfreezing access to data by third parties without requiring a user to navigate completely away from a third-party web server through which the user is executing a transaction. In one example, the functionalities provided herein are provided by a server computing system. The server computing system can include a processor and a non-transitory computer-readable storage device including instructions. When executed by the processor, the instructions can cause the processor to process an unlock webpage request for a user interface for unlocking or unfreezing data about a user, the unlock webpage request being sent based on a third-party web server receiving an application request on a third-party website hosted by the third-party web server, the processing including storing information about the user in a cache based on determining that the data about the user is locked. The instructions can further cause the processor to transmit the user interface that is displayable simultaneously with at least part of the third-party website. The instructions can cause the processor to process an unlock request for unlocking or unfreezing the data about the user based on information provided via the user interface, the information including consent to unlock or unfreeze the data about a user, the processing including comparing the information of the user with the cache and causing the data about the user to be unlocked or unfrozen based on the information of the user matches the cache. The instructions can further cause the processor to process a data access request for accessing unlocked data about the user, the processing including transmitting the unlocked data based on determining that the data about the user is unlocked.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment that allows a user to request data about the user to be unlocked or unfrozen and consent for data to be provided to a third-party web server for conducting electronic transactions with the third-party web server, according to certain aspects of the present disclosure.

FIG. 2 is a flow chart depicting an example of a process for managing access to locked or frozen data, according to certain aspects of the present disclosure.

FIG. 3 includes several flow charts depicting several processes for processing an unlock webpage request for a user interface for unlocking or unfreeze data, according to certain aspects of the present disclosure.

FIG. 4 includes several flow charts depicting several processes for processing an unlock request for unlocking or unfreezing the data about a user, according to certain aspects of the present disclosure.

FIG. 5 depicts an example of an unlock webpage that overlays a third-party base website and can be used by a user to provide approval or consent to unlock or unfreeze data about the user by the third-party web server, according to certain aspects of the present disclosure.

FIG. 6 depicts an example of another unlock webpage that overlays a third-party base website and can be used by a user to provide a time duration for unlocking or unfreezing data about the user by the third-party web server, according to certain aspects of the present disclosure.

FIG. 7 depicts an example of a webpage that overlays a third-party base website and can be used by a user to provide additional information to authenticate the user, according to certain aspects of the present disclosure.

FIG. 8 includes several flow charts depicting several processes for processing a data access request for accessing unlocked data about a user, according to certain aspects of the present disclosure.

FIG. 9 is a flow chart depicting an example of a process for checking and updating the access status for unlocked or unfrozen data, according to certain aspects of the present disclosure.

FIG. 10 depicts an example of a computing system that can be configured to perform certain aspects of the present disclosure.

### DETAILED DESCRIPTION

Certain aspects and features of the present disclosure relate to providing access and control for unlocking or unfreezing access to data about a user by third parties without requiring the user to navigate completely away from a web server through which the user is executing a transaction. An access management server can manage access between a third-party web server and one or more data sources by obtaining consent from a user and allowing the user to control access to data in the data sources. In one example, an online workflow can create a seamless transaction between a user, a third party, and a data source without the need for the user to switch between multiple external applications. The third party can be allowed to request access to any protected data source. The user can authorize the access if the data is frozen or locked, giving temporary access to the requesting third party for the transaction.

For example, an access management server may receive an unlock webpage request for a user interface for unlocking or unfreeze data about a user. The request may be sent through a third-party web server receiving an application request on a third-party website hosted by the third-party web server. The access management server can validate the request, such as the user information contained in the request. Based on a successful validation, the access management server can search the protected data store for the data about the user and determine the access status of the data. If the data is locked or frozen, the access management server can send the unlock webpage (or a link to the unlock webpage) to the third-party web server to have the unlock webpage presented in a website of the third-party web server. The access management server can further cache the user identify and other information about the user in a cache. If the access status of the data about the user is unlock or unfrozen, there is no need to unlock or unfreeze the data. In such a scenario, the access management server can return an error message to the third-party web server.

A user can request the data about the user to be unlocked or unfrozen through the unlock webpage of the access management server presented in the third-party website. The unlock webpage can be configured to obtain the consent of the user to unlock or unfreeze the data, the duration of the unlocking or unfreezing, and other information required to request the unlocking or unfreezing. An unlock request can be generated to include the information and sent to the access management server. The access management server can validate the unlock request and search the protected datastore to identify the data about the user. The access management server can further search the cache to find a match for the user ID in the request. If the search finds a match, the access management server can have the protected data about the data to be unlocked or unfrozen. If the search does not find a match, the access management server can return an error message.

The third-party web server can send a request for the data about the user to the access management server, for example, during the process of an online activity or transaction. The access management server can search the protected data store to find the data about the user and determine the access status of the data. If the data is unlocked or unfrozen, the data can be returned to the third-party web server. If the data is locked or frozen, the access management server can return a failure message to the third-party web server.

In some examples, the data about a user can be unlocked or unfrozen for one or more specific third parties and remain locked or frozen for other third parties. In those examples, the access management server can, upon determining that the data for the requested user is locked or frozen, check a list of authorized third parties for which the data about the user is unlocked or unfrozen. If the third party sending the request is on the list, then the access management server can return the unlocked or unfrozen data to the third-party web server; otherwise, the failure message can be returned.

As discussed above, the system can temporarily unlock or unfreeze the data about a user for a time period. The start and end time for the data can be included in the access status of the data about the user. To ensure the data is relocked once the re-lock time has expired, a protected data system configured for managing the protected datastore can continuously check the re-lock times of the data. The protected data system can maintain a list of user IDs for which the data is unlocked or unfrozen. For each user ID in the list, the protected data system can search the protected datastore and retrieve the access status of the data about the user with the user ID. The protected data system can further compare the relock time with the current time. If the relock time has expired, the protected data system can remove the unlock status for the user ID. In examples where the data is unlocked or unfrozen for a particular third party, the protected data system can compare the current time with the relock time for the particular third party and remove the unlock status for the user ID for the particular third party.

In further examples, the user is being authenticated before the data about the user is unlocked or unfrozen. Because the unlock request may include user information such as the user ID, the name of the user, the address of the user, and so on, the access management server can authenticate the user without asking for the user’s login information with the access management server. The access management server can use an authenticator created for the user (e.g., cryptographical keys created from a previous authentication session from a different or the same third-party) to authenticate the user. The authenticator can be used to authenticate the user through one time passcode sent to a device associated with the user. In some examples, the access management server authenticates the user based on a risk assessment performed for the user. For low risks, the user can be authenticated using the authenticator as discussed above. If the access management server determines a high risk associated with the request to unlock or unfreeze the data, the access management server can request additional information from the user, such as a copy of the driver’s license of the user.

As described herein, certain embodiments provide improvements to online computing environments by solving problems that are specific to online platforms. These improvements include providing an integrated and seamless online transaction workflow that speed up an online transaction process. The improvements also include a reduced usage of network bandwidth because there are fewer communications transmitted between the user device, the third-party web servers and the data sources to provide the necessary information for the online transaction.

In addition, certain embodiments address the problem of retaining website users who, if adhering to the routine, conventional functioning of a website hosting the online transaction, would be sent away from the website after finding out that the data required for the transaction is locked or frozen. The embodiments presented herein allow a website user to click on a user interface control, such as an icon, on the third-party website while the user is in the process of completing the online transaction, to unlock or unfreeze the data without leaving the third-party website. In this way, rather than losing visitors or users, the third-party website can send its visitors or users to a website or a web page that can be simultaneously presented with the third-party website and are provided by the access management server for unlocking or unfreezing data without the users separately visiting the data sources’ websites.

These illustrative examples are given to introduce the reader to the general subject matter discussed here and are not intended to limit the scope of the disclosed concepts. The following sections describe various additional features and examples with reference to the drawings in which like numerals indicate like elements, but should not be used to limit the present disclosure.

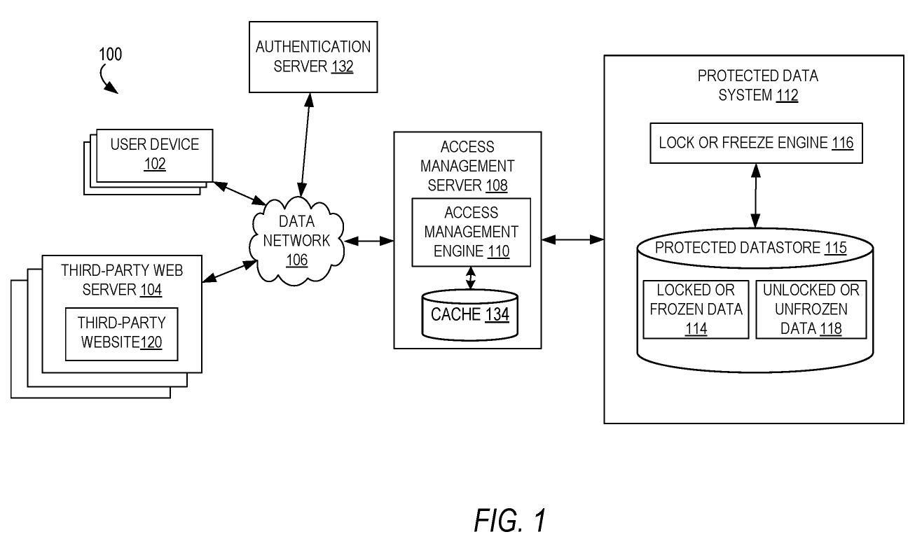

FIG. 1 depicts an example of a computing environment 100 that allows a user, via a user device 102, to request to unlock or unfreeze data and to consent for the unlocked or unfrozen data to be provided to a third-party web server 104 for conducting electronic transactions, such as credit card applications, with third-party web servers 104 that are operated by or otherwise associated with third parties. FIG. 1 depicts examples of hardware components of a computing environment 100 according to some aspects. The computing environment 100 is a specialized computing system that may be used for performing large amounts of authentication operations using a large number of computer processing cycles.

The devices depicted in FIG. 1 are provided for illustrative purposes. Different numbers of devices may be used. For example, while certain devices or systems (e.g., an access management server 108, a protected data system 112, a protected datastore 115, etc.) are shown as single devices in FIG. 1, multiple devices may instead be used to implement these devices or systems (e.g., a cloud or grid-based telecommunications network server system, a group of network-attached storage devices, etc.).

The computing environment 100 can include one or more user devices 102. The user devices 102 may include client devices that can communicate with the access management server 108. The user device 102 may be a personal computer (“PC”), a desktop workstation, a laptop, a notebook, an electronic-book reader, a smartphone, a wearable computing device, a game console, a set-top box, a consumer electronics device, a server computer, or any other computing device capable of communicating with the access management server 108 or other devices in the computing environment 100. For example, the user devices 102 may send data to the access management server 108 to be processed, may send signals to the access management server 108 to control different aspects of the computing environment or the data that the access management server 108 is processing. The user devices 102 may interact with the access management server 108 via one or more data networks 106.

The computing environment 100 can include one or more third-party web servers 104. Each third-party web server 104 may include one or more third-party electronic devices (e.g., computing devices or groups of computing devices), such as individual servers or groups of servers operating in a distributed manner. A third-party web server 104 can communicate with the access management server 108. For example, third-party web servers 104 may send data to the access management server 108 to be processed, may send signals to the access management server 108 to control different aspects of the computing environment or the data that the access management server 108 is processing. The third-party web servers 104 may interact with the access management server 108 via one or more data networks 106. The third-party web servers 104 may also interact with the user devices 102 via one or more data networks 106 to facilitate electronic transactions between users of the user devices 102 and third parties that use, operate, or are otherwise associated with the third-party web servers 104.

For instance, the electronic transactions might involve credit card applications and the third-party web servers 104 may be associated with a bank or a credit card company. To facilitate the credit card applications or other types of electronic transactions, the third-party web server 104 can present a third-party website 120 on the third-party web servers 104. By visiting and interacting with the third-party website 120 hosted by the third-party web servers 104 through a user device 102, a user may apply for a credit card with the bank or the credit card company by providing information for the application, submitting the application, obtaining an approval decision of the application, and so on. While the term “website” is used herein, the third-party website 120 can be a user interface other than a website or a webpage, such as a user interface of a client-side application executing on the user device 102, such as the user interface of an app executing on a laptop or a smartphone of the user and communicating with the third-party web servers 104.

Some electronic transactions can involve sensitive data about the user from data sources, such as credit bureau data asset (e.g., Equifax, TransUnion, or Experian credit file, Work Number file, NCTUE credit file, etc.). Due to their sensitivity, these data might be protected and locked or frozen from access by the third-party web servers 104. In order to facilitate the electronic transactions, the third-party web servers 104 can communicate with the access management server 108 to integrate the process of unlocking or unfreezing the data about the user within the process of the electronic transactions. Through the integrated process, the user can communicate with the access management server 108 to provide authorization or consent to share the data about the user with the third-party web servers 104, to authorize other ancillary actions by the access management server 108, and so on.

The access management server 108 may be a specialized computer or other machine that processes the data received within the computing environment 100. The access management server 108 can include one or more processing devices that execute program code, such as an access management engine 110. The program code is stored on a non-transitory computer-readable storage medium of the access management server 108. The access management engine 110 can execute a set of operations for managing communications from a user of a user device 102. The access management engine 110 can also configure the access management server 108 to communicate data with one or more third-party web servers 104 and a protected data system 112 to control access to data in the protected data system 112 with respect to the third-party web servers 104. In some examples, the access management server 108 can be included in the protected data system 112.

The protected data system 112 may include or be configured to manage a protected datastore 115 which can store a variety of different types of data organized in a variety of different ways and from a variety of different data sources. For example, the protected datastore 115 may include storage other than primary storage located within the protected data system 112 that is directly accessible by processors located therein. In some aspects, the protected datastore 115 may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as compact disk or digital versatile disk, flash memory, memory or memory devices.

The protected datastore 115 can include memory devices for storing locked or frozen data 114 and unlocked or unfrozen data 118. The locked or frozen data 114 can include data about a user that is prevented from being accessible by third parties. The protected data system 112 further includes a lock or freeze engine 116 which can respond to commands from the access management server 108 to unlock or unfreeze the data 114 and transform the data 114 into unlocked or unfrozen data 118 that can be accessed by third parties. The lock or freeze engine 116 can also lock or freeze data 118 to transform data 118 into locked or frozen data 114. In some examples, the locked or frozen data 114 and unlocked or unfrozen data 118 are stored together and each data is associated with an access status to indicate whether the data is locked or unlocked and the conditions of the unlock (e.g., the third parties allowed to access the unlocked data, or the time period for the data being unlocked or unfrozen).

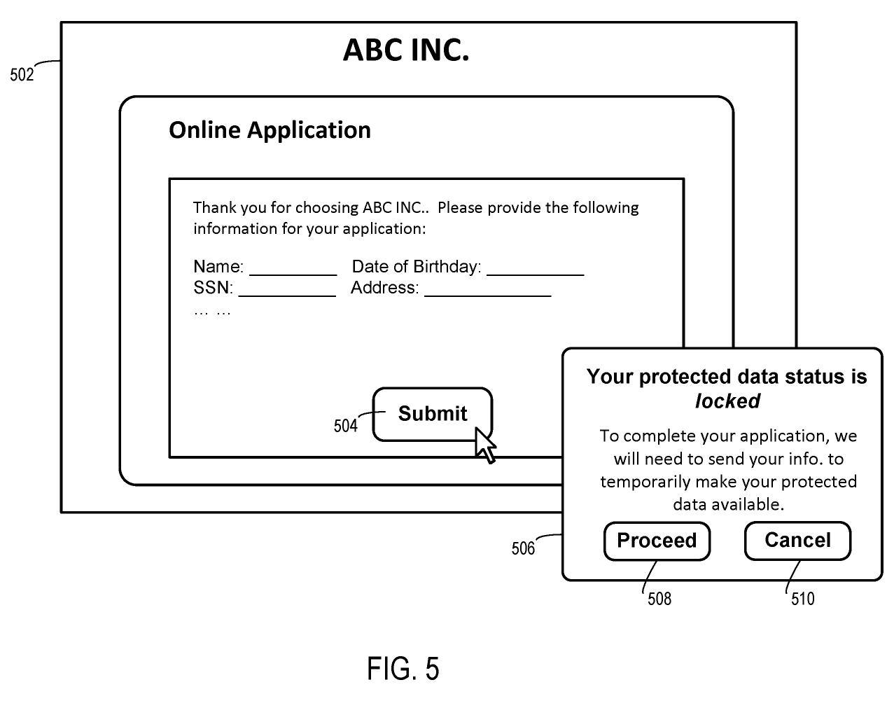

In order for the user to unlock or unfreeze data in the process of an electronic transaction, the access management server 108 can generate a separate user interface, such as a website or a webpage separate from the third-party website 120 that can be presented within the third-party website 120. For example, the separate user interface can be embedded into the third-party website 120 so that the user does not need to leave the third-party website 120 when communicating with the access management server 108. In another example, the separate user interface can be presented as a pop-up user interface overlaying the third-party website 120 or a portion thereof. Other ways of presenting the separate user interface without the user leaving the third-party website 120 can be implemented. Additional examples of generating and presenting the separate user interface will be presented below with regard to FIGS. 5-7.

Through the separate user interface, the user can review and authorize or consent to the access to the data, such as the credit bureau data asset, by the third-party web servers 104. In some examples, the user is being authenticated before the data about the user is unlocked or unfrozen. Because the request to unlock the data may include user information such as the user ID, the name of the user, the address of the user, and so on, the access management server 108 can authenticate the user without asking for the user log in information with the access management server 108. The access management server can use an authenticator created for the user (e.g., cryptographical keys created from a previous authentication session from a different or the same third-party) to authenticate the user. The authenticator can be used to authenticate the user through one time passcode sent to a device associated with the user. In some examples, the access management server authenticates the user based on a risk assessment performed for the user. The risk assessment may be performed based on information provided by another systems, such as an authentication server 132. The authentication server 132 may report abnormal activities related to the user or the devices associated with the user, such as the user device has an unseen IP address, the operating system of the user device is outdated, the SIM card on the user’s mobile device has been replaced, and so on. For scenarios where no abnormal activities are observed (low risks), the user can be authenticated using the authenticator. If one or more abnormal activities associated with the user or the user devices have been observed, the access management server 108 may determine there is a high risk associated with the request to unlock the data or request for the data. In that case, the access management server can request additional information from the user, such as a copy of the driver’s license of the user.

Based on the authorization and the authentication of the user, the unlocked or unfrozen data 118 can be transmitted to the third-party web servers 104 through the access management server 108 or without going through the access management server 108. For example, the data 118 can be transmitted to the third-party web servers 104 via the data network 106 without being transmitted to the access management server 108.

In some examples, the lock or freeze engine 116 or other components in the computing environment 100, such as the access management engine 110, can include a decisioning module that can determine a decision for the third party based on the data of the user and provide the decision to the third-party web server 104, with or without data about the user. In other examples, the lock or freeze engine 116 or other components in the computing environment 100, such as the access management engine 110, can pre-fill the data for the electronic transaction, such as pre-filling the credit card application, using the data about the user. The pre-filled electronic transaction can be transmitted to the third-party web server 104, with or without the unlocked data about the user. In these examples, the separate user interface can also include a mechanism, such as a button, a check box, or other selectable user interface control, to allow the user to authorize these ancillary actions, such as pre-filling the credit card application or providing the decision for the third party.

In some implementations, the data about the user is unlocked or unfrozen permanently until the protected data system 112 receives another request authorized by the user to lock or freeze the data. In this way, a subsequent electronic transaction can be executed by the user on the third-party website 120 without interacting with the separate user interface provided by the access management server 108. In other implementations, the data about the user is unlocked or unfrozen temporarily for a period of time specified by the user and the data is locked or frozen again after the specified time period expires. As a result, the user would go through the above process again for a subsequent electronic transaction.

Each communication within the computing environment 100 (e.g., between user devices 102 and the access management server 108, between third-party web servers 104 and the access management server 108, etc.) may occur over one or more data networks 106. A data network 106 may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network 106.

A data network 106 may include network computers, sensors, databases, or other devices that may transmit or otherwise provide data to telecommunications network servers. For example, a data network 106 may include local area network devices, such as routers, hubs, switches, or other computer networking devices. The data network 106 can be incorporated entirely within (or can include) an intranet, an extranet, or a combination thereof. In one example, communications between two or more systems or devices can be achieved by a secure communications protocol, such as secure sockets layer (“SSL”) or transport layer security (“TLS”). In addition, data or transactional details may be encrypted.

The features discussed herein are not limited to any particular hardware architecture or configuration. A computing device can include any suitable arrangement of components that provide a result conditioned on one or more inputs. Suitable computing devices include multipurpose, microprocessor-based computing systems accessing stored software that programs or configures the computing system from a general-purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

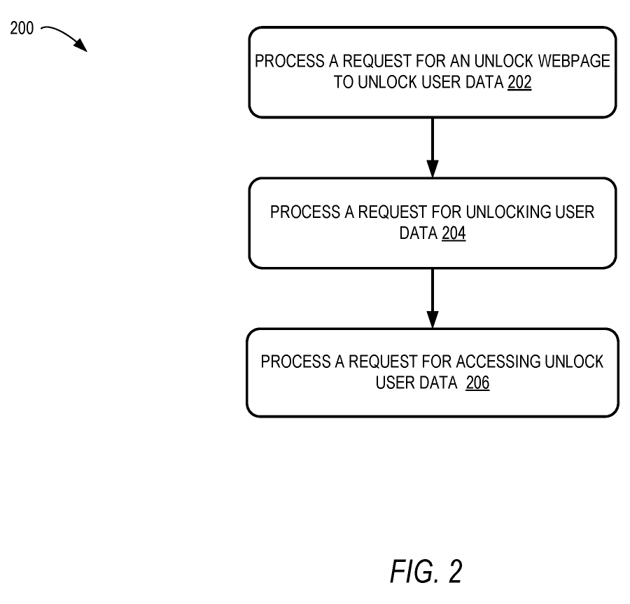

FIG. 2 is a flow chart depicting an example of a process 200 for managing access to locked or frozen data, according to certain aspects of the present disclosure. One or more computing devices (e.g., the access management server 108 in the computing environment 100) implement operations depicted in FIG. 2 by executing suitable program code (e.g., the access management engine 110). For illustrative purposes, the process 200 is described with reference to certain examples depicted in the figures. Other implementations, however, are possible.

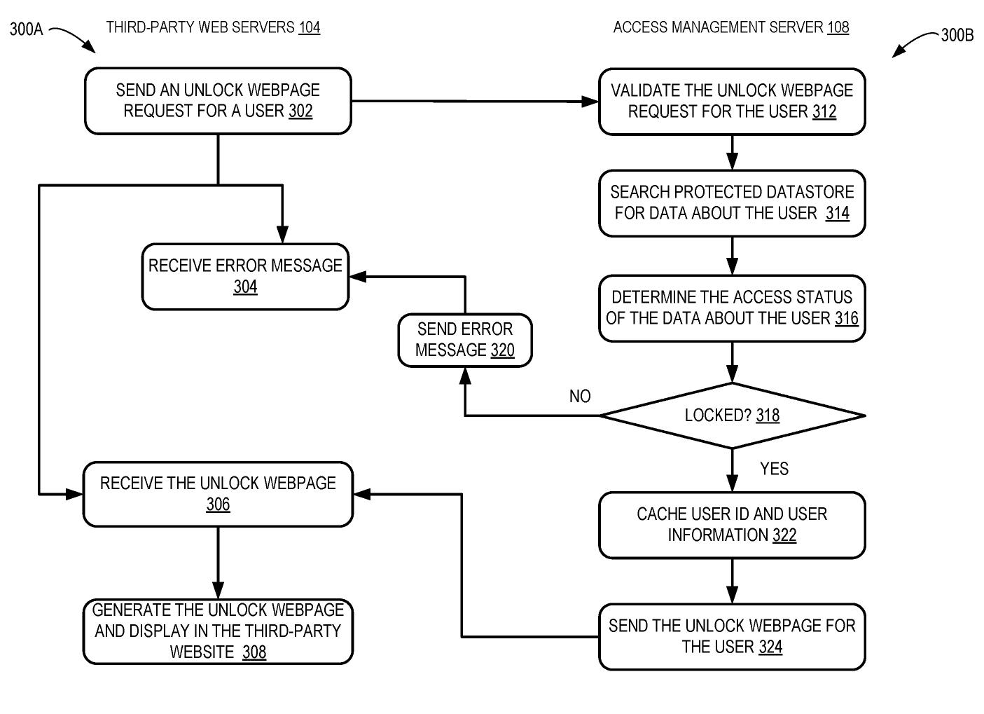

At block 202, the process 200 involves processing a request for an unlock webpage to unlock or unfreeze data about a user, also referred to as an “unlock webpage request.” The request may be sent through a third-party web server 104 receiving an application request on a third-party website 120 hosted by the third-party web server 104. The access management server 108 can validate the request and based on a successful validation, the access management server 108 can search the protected data store for the data about the user and determine the access status of the data. If the data is locked or frozen, the access management server can send the unlock webpage (or a link to the unlock webpage) to the third-party web server 104 to have the unlock webpage presented in the third-party website 120. Additional details about processing an unlock webpage request are provided below with respect to FIG. 3.

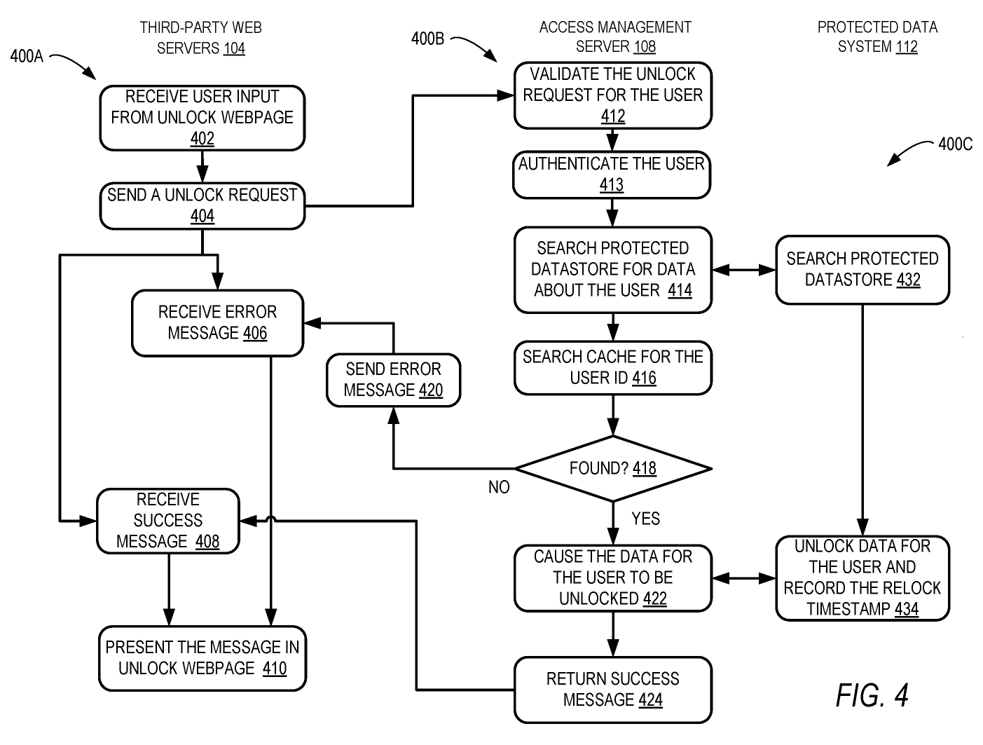

At block 204, the process 200 involves processing a request for unlocking or unfreezing the data about the user, also referred to as an “unlock request.” Through the unlock webpage presented in the third-party website 120, a user can request the data about the user to be unlocked. As such, the unlock request can include the user ID, user information, the consent of the user to unlock or unfreeze the data, the duration of the unlocking or unfreezing, and other information required to request the unlocking or unfreezing. The access management server can validate the request and search the protected datastore to identify the data for the user. The access management server can further search a cache to find a match for the user ID in the request. If the search finds a match, the access management server can have the protected data about the data to be unlocked or unfrozen. If the search does not find a match, the access management server can return an error message. Additional details about processing an unlock request are provided below with respect to FIGS. 4-7.

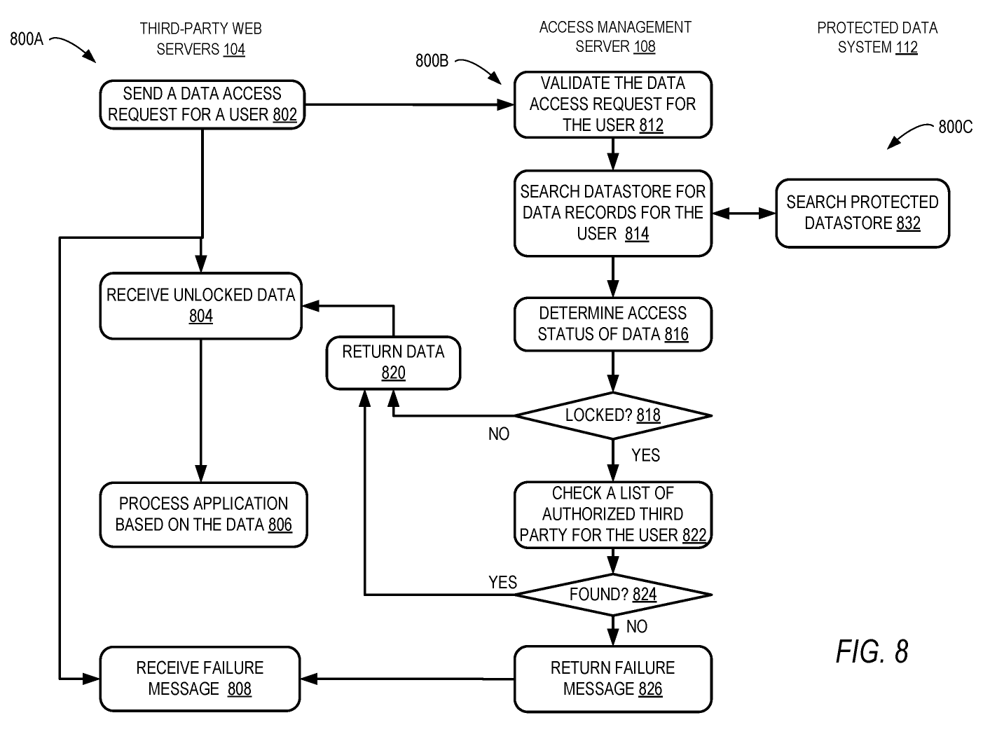

At block 206, the process 200 involves processing a request for accessing unlocked data about the user, also referred to as an “data access request.” The third-party web server can send a request for the data about the user to the access management server, for example, during the process of an online activity or transaction. The access management server can search the protected data store to find the data about the user and determine the access status of the data. If the data is unlocked or unfrozen, the data can be returned to the third-party web server. If the data is locked or frozen, the access management server can return a failure message to the third-party web server. Additional details about accessing unlocked data about a user are provided below with respect to FIG. 8.

Referring now to FIG. 3, FIG. 3 includes several flow charts depicting several processes 300A and 300B for processing an unlock webpage request for a user interface for unlocking or unfreeze data, according to certain aspects of the present disclosure. In particular, the process 300A illustrates aspects of the third-party web server 104 and the process 300B illustrates aspects of the access management server 108 with regard to the embodiment described above with regard to FIG. 1. The process 300B can be utilized to implement block 202 of FIG. 2. Other implementations, however, are possible. The processes 300A and 300B will be described together below.

At block 302, the process 300A involves sending an unlock webpage request for a user. The third-party web servers 104 can generate the unlock webpage request for the user during an electronic transaction between the user and the third-party web server 104 and based on a selection of a user interface element on a third-party website 120 hosted by the third-party web server 104. For example, the request can be generated when the user activates a button to submit an application. In order to process the application, the third-party web servers 104 can identify the required data. If the required data involve protected data about the user, the third-party web servers 104 can submit a request for a unlock webpage for obtaining consent and information for unlocking or unfreezing the protected data for the user. The request can include information such as the identifier of the user (user ID) and user information such as the name of the user, the address of the user, and so on. The user information can be obtained, for example, from the application data submitted by the user through the third-party website.

At block 312, the process 300B involves validating the unlock webpage request for the user. The validation could include verifying whether the information contained in the request is sufficient to identify the user. If the validation is successful, the process 300B involves, at block 314, searching the protected datastore 115 for data about the user using the user information contained in the request.

If the data about the user is found in the protected datastore 115, the process 300B involves, at block 316, determining the access status of the data about the user. In some examples, the access status of the data about a user is indicated using a flag with 0 indicating locked or frozen and 1 indicating unlocked or unfrozen, or vice versa. The flag can be stored in the protected datastore 115 along with the data about the user. In further examples where the data about a user can be unlocked or unfrozen for specific third parties, the access status can be further indicated using a list of the third parties for which the data is unlocked or unfrozen, in addition to the flag. In those examples, the flag can be set to be 0 indicating the data is locked or frozen and the list can include the third parties that is authorized to access the unlocked or unfrozen data even if the flag shows it is being locked or frozen.

At block 318, the process 300B involves determining whether the data about the user is locked or frozen for the third party. If so, the process 300B involves, at block 320, sending an error message to the third-party web servers 104. In other words, if the data about the user is unlocked or unfrozen for the third party associated with the third-party web servers 104, there is no need to present the unlock webpage to the user. At block 304, the process 300A involves receiving the error message. Based on the error message, the third-party web servers 104 may determine to request the unlocked or unfrozen data as discussed below with respect to FIG. 8.

If, at block 318, the access management server 108 determines that the access status of the data about the user is locked for the third party, the process 300B involves, at block 322, caching the user ID and user information in a cache. At block 324, the process 300B involves sending the unlock webpage to the third-party web servers 104. In some implementations, sending the unlock webpage is performed by sending a link to the unlock webpage (or a link to the code that can be used to generate the unlock webpage) to the third-party web servers 104.

At block 306, the process 300A involves receiving the unlock webpage. At block 308, the process 300A involves generating the unlock webpage and presenting it in conjunction with the third-party website 120 so that the user does not need to navigate completely away from the third-party website 120 through which the user is executing the transaction. The third-party website 120 may also be referred to herein as a “base website.” The unlock website may overlay part of a base website or may be embedded into the base website. In some cases, the unlock webpage has similar look and feel as the third-party website 120.

FIG. 4 includes several flow charts depicting several processes 400A, 400B, and 400C for processing an unlock request for unlocking or unfreezing the data about a user, according to certain aspects of the present disclosure. In particular, the process 400A illustrates aspects of the third-party web servers 104; the process 400B illustrates aspects of the access management server 108, and the process 400C illustrates aspects of the protected data system 112, with regard to the embodiment described above with regard to FIG. 1. The process 400B can be utilized to implement block 204 of FIG. 2. Other implementations, however, are possible. The processes 400A, 400B, and 400C will be described together below. FIG. 4 will be described in conjunction with FIGS. 5-7.

At block 402, the process 400A involves receiving user input from the unlock webpage. In some examples, the unlock webpage includes multiple unlock user interfaces each user interface requesting different information from the user. For example, an unlock user interface can be configured to request from the user the consent to unlock or unfreeze the data; another user interface can be used to request the unlock or unfreeze time duration.

FIG. 5 shows an example of an unlock webpage that overlays a third-party base website and can be used by a user to provide approval or consent to unlock or unfreeze data about the user by the third-party web server, according to certain aspects of the present disclosure. In this example, a base website 502 is served by a web server 104 associated with a third party “ABC Inc.” The base website 502 includes a button 504 for submitting an online application for an electronic transaction. In response to the submit button 504 being selected, the third-party web servers 104 can determine the data required to process the application by the user. If the data includes protected data for the user, the third-party web servers 104 can request an unlock webpage from the access management server 108 for the user as discussed above with respect to FIG. 3. If the data about the user is locked for the third party ABC Inc., the access management server 108 can generate the unlock webpage and present it along with the base website as discussed above with respect to block 308 of FIG. 3. In the example shown in FIG. 5, an unlock webpage 506 is presented allowing a user to provide consent to unlock or unfreeze data. The user can provide the consent by clicking on the “Proceed” button 508 or deny the unlocking or unfreezing by clicking on the "Cancel” button 510.

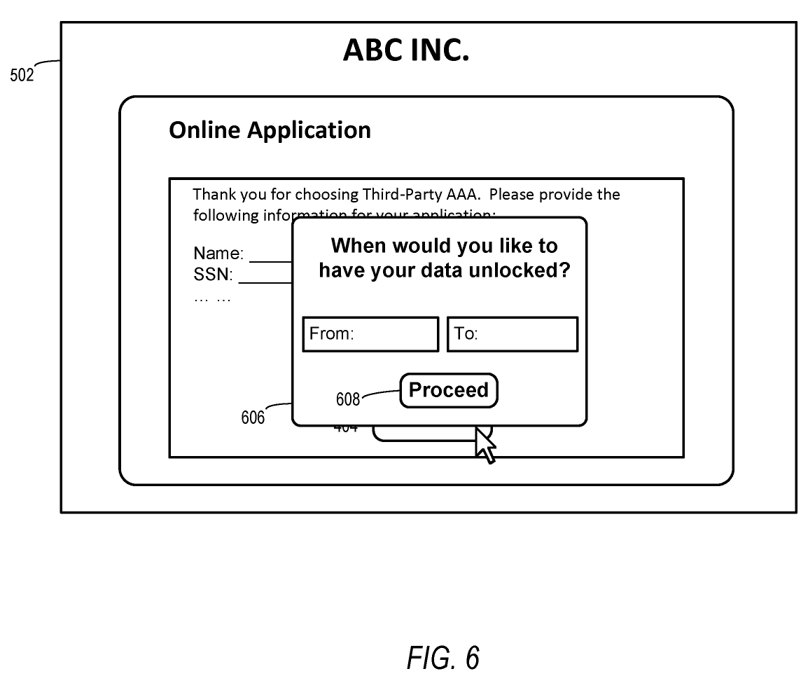

FIG. 6 depicts an example of another unlock webpage 606 that overlays the third-party base website shown in FIG. 5 and can be used by a user to provide a time duration for unlocking or unfreezing data about the user, according to certain aspects of the present disclosure. The unlock webpage 606 allows the user to specify the start and end time of the unlocking or unfreezing. In some implementations, the start time includes the start date and time (in terms of hours or minutes) and similarly, the end time includes the end date and time (in terms of hours or minutes). In other words, the user can control the duration of the data to be unlocked or unfrozen to the hour or minute level. In this way, the user is provided with more flexibility in controlling the access of the data. The user can click on the “Proceed” button 608 to move to the next step of the unlocking or unfreezing process.

Referring back to FIG. 4, the process 400A involves, at block 404, sending an unlock request to the access management server 108. The unlock request can include the user ID, the user information, the identifier of the third party, the duration of the unlocking or unfreezing, and so on. At block 412, the process 400B involves validating the received unlock request for the user. The validation could include verifying whether the information contained in the request is sufficient to identify the user, the third party and to unlock or unfreeze the data.

If the validation is successful, the process 400B involves, at block 413, authenticating the user. Because the unlock request may include user information such as the user ID, the name of the user, the address of the user, and so on, the access management server can authenticate the user without asking for the user’s login information with the access management server. The access management server can use an authenticator created for the user (e.g., cryptographical keys created from a previous authentication session from a different or the same third party) to authenticate the user. The authenticator can be used to authenticate the user through, for example, one time passcode sent to a device associated with the user. In some examples, the access management server authenticates the user based on a risk assessment performed for the user. The risk assessment may be performed based on information provided by another systems, such as the authentication server 132. The authentication server 132 may report abnormal activities related to the user or the devices associated with the user, such as the user device has an unseen IP address, the operating system of the user device is outdated, the SIM card on the user’s mobile device has been replaced, and so on. For scenarios where no abnormal activities are observed (low risks), the user can be authenticated as discussed above. If one or more abnormal activities associated with the user or the user devices have been observed, the access management server 108 may determine there is a high risk associated with the request to unlock the data or request for the data. In that case, the access management server can request additional information from the user.

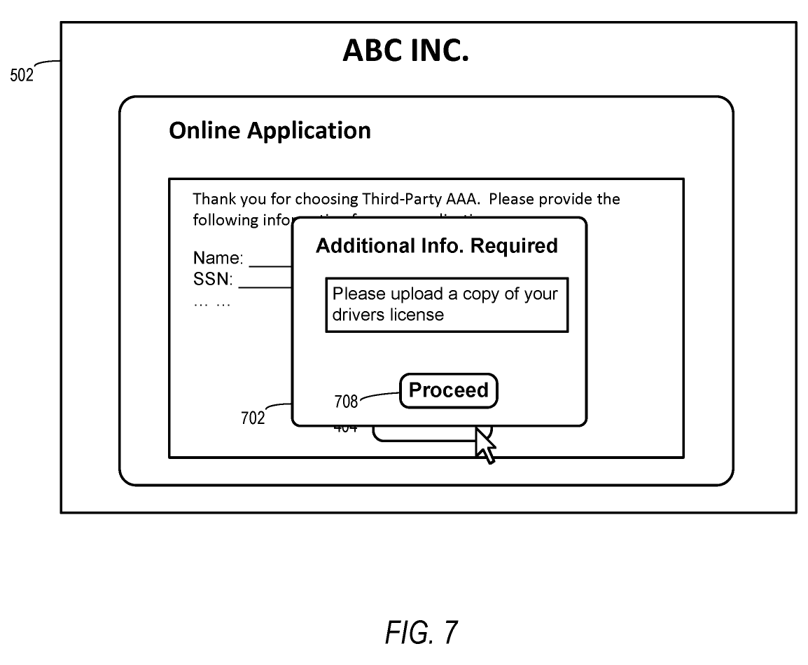

FIG. 7 depicts an example of a webpage that overlays a third-party base website and can be used by a user to provide additional information to authenticate the user, according to certain aspects of the present disclosure. In this example, the access management server 108 sends an authentication webpage 702 to the third-party web servers 104 to request additional information about the user, a copy of the driver’s license of the user in this case. The user can use the user interface controls on the webpage to provide the requested information. The user can further click on the “Proceed” button 708 to move to the next step of the unlocking or unfreezing process. While FIG. 7 shows the webpage for requesting a copy of the user’s driver’s license, other webpages can be used in a similar way to request information needed for the authentication. For example, if the access management server 108 is unable to use the user information from the application or transaction executed at the third-party web servers 104, the access management server 108 can send webpages to the third-party web server 104 to request the user to enter the user information needed for authentication.

Referring back to FIG. 4, if the authentication is successful, the process 400B involves, at block 414, searching the protected datastore 115 for data about the user using the user information contained in the unlock request. In some examples, the search involves submitting a search request to the protected data system 112, which causes the protected data system 112 to perform the search in the protected datastore 115, as shown in block 432 of the process 400C.

If the data about the user is found in the protected datastore 115, the process 400B involves, at block 416, searching the cache 134 for the user ID. At block 418, the process 400B involves determining if the user ID is found in the cache 134 and whether the user information in the unlock request matches the user information stored in the cache 134. If no, the process 400B involves, at block 420, sending an error message to the third-party web servers 104. Because the cache 134 is cleared periodically, such as every hour, an unlock request sent long after the unlock webpages are sent will be denied. This increases the security of the system by reducing the time window during which attackers can attack the access management server 108 (e.g., by submitting malicious unlock requests). At block 406, the process 400A involves receiving the error message and presenting it in the unlock webpage.

If the user ID is found in the cache 134 and the user information in the unlock request matches the user information stored in the cache 134, the process 400B involves, at block 422, causing the protected data system 112 to unlock the data about the user in the protected datastore 115. The protected data system 112 can, at block 434, unlock the data about the user in the protected datastore 115 and modify or add the flag indicating the data about the user is unlocked. In examples where the data about a user is unlocked or unfrozen specifically for the third party, the protected data system 112 can add the third party to the list of authorized third parties for the data about the user.

At block 424, the process 400B involves returning a success message to the third-party web servers 104. The third-party web servers 104 receives the success message at block 408 and presents it in the unlock webpage.

FIG. 8 includes several flow charts depicting several processes 800A, 800B, and 800C for processing a data access request for accessing unlocked data about a user, according to certain aspects of the present disclosure. In particular, the process 800A illustrates aspects of the third-party web servers 104; the process 800B illustrates aspects of the access management server 108, and the process 800C illustrates aspects of the protected data system 112, with regard to the embodiment described above with regard to FIG. 1. The process 800B can be utilized to implement block 206 of FIG. 2. Other implementations, however, are possible. The processes 800A, 800B, and 800C will be described together below.

At block 802, the process 800A involves sending data access request for a user to the access management server 108. The third-party web server 104 can generate the data access request for the user during an electronic transaction between the user and the third-party web server 104 and based on a selection of a user interface element on a third-party website 120 hosted by the third-party web server 104. For example, the request can be generated when the user activates a button to submit an application. In order to process the application, the third-party web servers 104 can identify the required data. If the required data involve protected data about the user and the data has been previously unlocked, the third-party web servers 104 can submit the data access request to request the unlocked or unfrozen data about the user. The data access request can include information such as the identifier of the user (user ID) and user information such as the name of the user, the address of the user, and so on. The user information can be obtained, for example, from the application data submitted by the user through the third-party website.

At block 812, the process 800B involves validating the data access request for the user. The validation could include verifying whether the information contained in the request is sufficient to identify the user and the third party. If the validation is successful, the process 800B involves, at block 814, searching the protected datastore 115 for data about the user using the user information contained in the request. In some examples, the search involves submitting a search request to the protected data system 112, which causes the protected data system 112 to perform the search in the protected datastore 115, as shown in block 832 of the process 800C.

If the data about the user is found in the protected datastore 115, the process 800B involves, at block 816, determining the access status of the data about the user. As discussed above, the access status of the data about a user is indicated using a flag with 0 indicating locked or frozen and 1 indicating unlocked or unfrozen, or vice versa. The flag can be stored in the protected datastore 115 along with the data about the user. In examples where the data about a user can be unlocked or unfrozen for specific third parties, the access status can be further indicated using a list of the third parties for which the data is unlocked or unfrozen, in addition to the flag. In those examples, the flag can be set to be 0 indicating the data is locked or frozen and the list can include the third parties that is authorized to access the unlocked or unfrozen data even if the flag shows it is being locked or frozen.

If it is determined, at block 818, that the data about the user is not locked, the process 800B involves, at block 820, sending the unlocked or unfrozen data about the user to the third-party web server 104. If, at block 818, the access management server 108 determines that the access status of the data about the user is locked, the process 800B involves, at block 822, checking the list of authorized third parties for the user. At block 824, the process 800B involves determining whether the third party is on the list of authorized third parties for the user. If so, the process 800B involves sending the unlocked or unfrozen data to the third-party web server 104 at block 820. At block 804, the process 800A involves receiving the unlocked or unfrozen data about the user. At block 806, the process 800A involves processing the application based on the received unlocked or unfrozen data.

If at block 824 it is determined that the third party is not on the list of authorized third parties for the user, the process 800B involves returning a failure message at block 826 indicating that the data is locked or frozen. At block 808, the process 800A involves receiving the failure message. Based on the failure message, the third-party web server 104 may determine that a request to unlock the data or the request to a unlock webpage may be needed to continue to process the application. In that case, the third-party web server 104 can employ the processes shown in FIGS. 3 and 4 as discussed above.

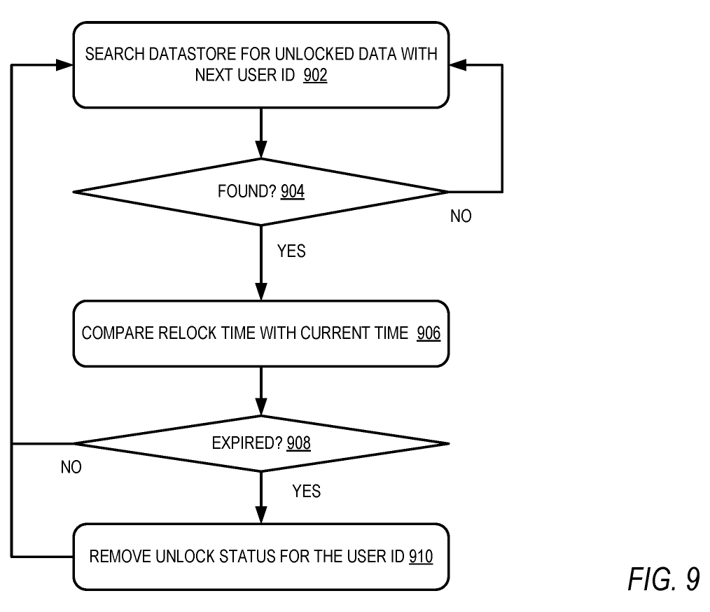

FIG. 9 is a flow chart depicting an example of a process for checking and updating the access status for unlocked or unfrozen data, according to certain aspects of the present disclosure. One or more computing devices (e.g., the protected data system 112 in the computing environment 100) implement operations depicted in FIG. 9 by executing suitable program code (e.g., the lock or freeze engine 116). For illustrative purposes, the process 900 is described with reference to certain examples depicted in the figures. Other implementations, however, are possible.

At block 902, process 900 involves searching protected datastore 115 for unlocked data about a user with a user ID. For example, the protected data system 112 can keep a list of user IDs whose data have been unlocked or unfrozen. The protected data system 112 can examine the user IDs in the list to determine whether to update the access status of the data. For the next user ID on the list, the protected data system 112 searches the protected datastore 115 to find the data about the user with the user ID.

At block 904, the process 900 involves determining whether the unlocked data about the user with the user ID has been found. If not, the process 900 moves to block 902 for the next user ID; if so, the process 900 involves comparing the relock time for the data with the current time. The relock time can be determined from the request to unlock or unfreeze data at the time when the data is being unlocked or unfrozen. When the user specifies the end time of the temporary unlocking or unfreezing, the relock time can be calculated and associated with the unlocked data. For example, the protected data system 112 can maintain a data structure storing the information associated with the unlocked data for users. For each user whose data has been unlocked or unfrozen, the data structure can maintain information such as the user ID, the user information, the end time, the list of authorized third parties, and so on. The relock time can be calculated from this data structure or pre-calculated and stored in the data structure. In examples where the data about the user can be unlocked or unfrozen for specific third parties, the data can have multiple relock times and the relock time for each authorized third party is compared with the current time.

At block 908, the process 900 involves determining whether the relock time for the user with the user ID has expired. If not, the process 900 moves to block 902 for the next user ID; if so, the process 900 involves removing unlock status for the user with the user ID at block 910. For example, if the data about the user is unlocked generally (that is, not specific for any third party), the protected data system 112 can change the unlock flag to 0. If the data about the user is unlocked for specific third parties, the protected data system 112 can remove the third parties whose associated relock times have expired from the list of authorized third parties. The process 900 moves to block 902 for the next user ID.

By using certain examples of the present disclosure, users can avoid navigating separately to a data source website to unlock or unfreeze data while in the process of completing an electronic transaction with the third party. And, multiple network exchanges (from user to data sources, from third-party website to data source, from data source back to third-party website to get confirmation or consent from user, from third-party website to data source to provide consent, from data source back to third-party to provide information, etc.) can be avoided such that a network’s latency can be reduced.

While the term “webpage” is used herein, the unlock webpage can be a user interface other than a webpage, such as a user interface of a client-side application executing on the user device 102, such as the user interface of an app executing on a laptop or a smartphone of the user and communicating with the third-party web servers 104.

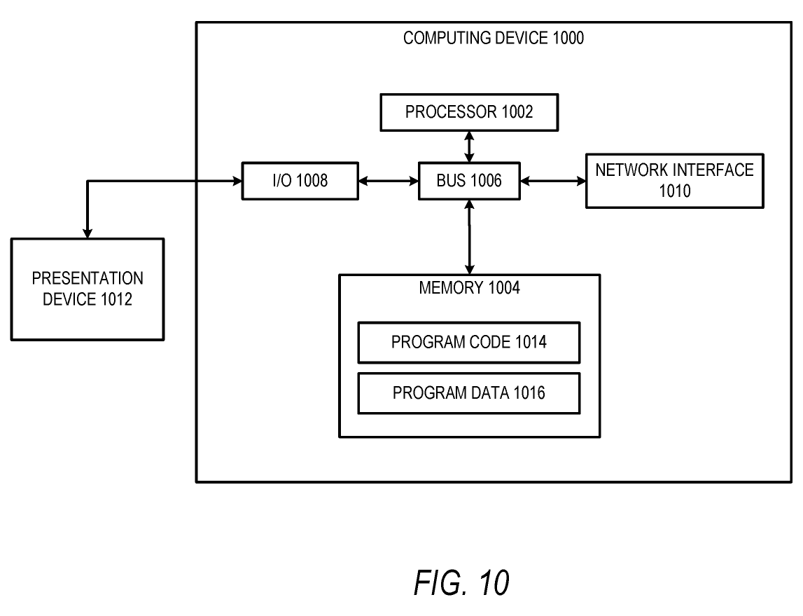

Any suitable computing system or group of computing systems can be used to perform the operations for the machine-learning operations described herein. For example, FIG. 10 is a block diagram depicting an example of a computing device 1000, which can be used to implement the access management server 108 or the protected data system 112 described with respect to FIG. 1. The computing device 1000 can include various devices for communicating with other devices in the computing environment 100, as described with respect to FIG. 1. The computing device 1000 can include various devices for performing one or more transformation operations described above with respect to FIGS. 1-9.

The computing device 1000 can include a processor 1002 that is communicatively coupled to a memory 1004. In some aspects, the processor 1002 can be referred to as a “processor device”. The processor 1002 executes computer-executable program code stored in the memory 1004, accesses information stored in the memory 1004, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 1002 include a microprocessor, an application-specific integrated circuit, a field-programmable gate array, or any other suitable processing device. The processor 1002 can include any number of processing devices, including one. The processor 1002 can include or communicate with a memory 1004. The memory 1004 stores program code that, when executed by the processor 1002, causes the processor to perform the operations described in this disclosure.

The memory 1004 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 1000 may also include a number of external or internal devices such as input or output devices. For example, the computing device 1000 is shown with an input/output interface 1008 that can receive input from input devices or provide output to output devices. A bus 1006 can also be included in the computing device 1000. The bus 1006 can communicatively couple one or more components of the computing device 1000.

The computing device 1000 can execute program code 1014 that includes the access management engine 110 or the lock or freeze engine 116. The program code 1014 for may be resident in any suitable computer-readable medium and may be executed on any suitable processing device. For example, as depicted in FIG. 10, the program code 1014 can reside in the memory 1004 at the computing device 1000 along with the program data 1016 associated with the program code 1014. Executing the program code 1014 can configure the processor 1002 to perform the operations described herein.

In some aspects, the computing device 1000 can include one or more output devices. One example of an output device is the network interface device 1010 depicted in FIG. 10. A network interface device 1010 can include any device or group of devices suitable for establishing a wired or wireless data connection to one or more data networks described herein. Non-limiting examples of the network interface device 1010 include an Ethernet network adapter, a modem, etc.

Another example of an output device is the presentation device 1012 depicted in FIG. 10. A presentation device 1012 can include any device or group of devices suitable for providing visual, auditory, or other suitable sensory output. Non-limiting examples of the presentation device 1012 include a touchscreen, a monitor, a speaker, a separate mobile computing device, etc. In some aspects, the presentation device 1012 can include a remote client-computing device that communicates with the computing device 1000 using one or more data networks described herein. In other aspects, the presentation device 1012 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A server computing system comprising:
a processor; and
a non-transitory computer-readable storage device comprising instructions that, when executed by the processor, cause the processor to:
process an unlock webpage request for a user interface for unlocking or unfreezing data about a user, the unlock webpage request being sent based on a third-party web server receiving an application request on a third-party website hosted by the third-party web server, the processing comprising storing information about the user in a cache based on determining that the data about the user is locked;
transmit the user interface that is displayable simultaneously with at least part of the third-party website;
process an unlock request for unlocking or unfreezing the data about the user based on information provided via the user interface, the information comprising consent to unlock or unfreeze the data about a user, the processing comprising comparing the information of the user with the cache and causing the data about the user to be unlocked or unfrozen based on the information of the user matches the cache; and
process a data access request for accessing unlocked data about the user, the processing comprising transmitting the unlocked data based on determining that the data about the user is unlocked.

2. The server computing system of claim 1, wherein the information provided via the user interface further comprises a validity period of time during which the data about the user is unlocked or unfrozen, wherein the data about the user is stored in a data store and data in the data store is maintained by:
for each user having a temporary unlock associated therewith, comparing a relock time with a current timestamp; and
based on the current timestamp has passed the relock time, relocking or freezing the data for the user.

3. The server computing system of claim 1, wherein the cache is cleared periodically.

4. The server computing system of claim 1, wherein transmitting the user interface comprises transmitting a link to a file usable to generate the user interface.

5. The server computing system of claim 1, wherein processing the unlock webpage request comprises:
searching a protected datastore for the data about the user;
based on the data about the user being found in the protected datastore, determining an access status of the data about the user; and
based on the access status of the data about the user being unlocked or unfrozen, transmitting an error message to the third-party web server.

6. The server computing system of claim 1, wherein processing the unlock request comprises authenticating the user by:
determining a risk level associated with the user; and
requesting additional information about the user based on the risk level by presenting an additional user interface requesting the additional information.

7. The server computing system of claim 1, wherein processing the unlock request comprises causing the data about the user to be unlocked or unfrozen in a protected datastore.

8. The server computing system of claim 1, wherein processing the data assess request comprises:
searching a protected datastore for data about the user;
determine an access status of the data about the user;
based on determining that the access status of the data about the user is locked, searching a list of authorized third parties for the user to determine a match of an identifier of a third party associated with the third-party web server; and
based on determining that the identifier of the third party associated with the third-party web server is on the list, send unlocked data to the third-party web server.

9. A method that includes one or more processing devices performing operations comprising:
processing an unlock webpage request for a user interface for unlocking or unfreezing data about a user, the unlock webpage request being sent based on a third-party web server receiving an application request on a third-party website hosted by the third-party web server, the processing comprising storing information about the user in a cache based on determining that the data about the user is locked;
transmitting the user interface that is displayable simultaneously with at least part of the third-party website;
processing an unlock request for unlocking or unfreezing the data about the user based on information provided via the user interface, the information comprising consent to unlock or unfreeze the data about a user, the processing comprising comparing the information of the user with the cache and causing the data about the user to be unlocked or unfrozen based on the information of the user matches the cache; and
processing a data access request for accessing unlocked data about the user, the processing comprising transmitting the unlocked data based on determining that the data about the user is unlocked.

10. The method of claim 9, wherein the information provided via the user interface further comprises a validity period of time during which the data about the user is unlocked or unfrozen, wherein the data about the user is stored in a data store and data in the data store is maintained by:
for each user having a temporary unlock associated therewith, comparing a relock time with a current timestamp; and
based on the current timestamp has passed the relock time, relocking or freezing the data for the user.

11. The method of claim 9, wherein transmitting the user interface comprises transmitting a link to a file usable to generate the user interface.

12. The method of claim 9, wherein processing the unlock webpage request comprises:
searching a protected datastore for the data about the user;
based on the data about the user being found in the protected datastore, determining an access status of the data about the user; and
based on the access status of the data about the user being unlocked, transmitting an error message to the third-party web server.

13. The method of claim 9, wherein processing the unlock request comprises authenticating the user by:
determining a risk level associated with the user; and
requesting additional information about the user based on the risk level by presenting an additional user interface requesting the additional information.

14. The method of claim 9, wherein processing the data assess request comprises:
searching a protected data store for data about the user;
determine an access status of the data about the user;
based on determining that the access status of the data about the user is locked, searching a list of authorized third parties for the user to determine a match of an identifier of a third party associated with the third-party web server; and
based on determining that the identifier of the third party associated with the third-party web server is on the list, send unlocked data to the third-party web server.

15. A non-transitory computer-readable storage medium having program code that, when executed by a processor device, to cause the processor device to perform operations, the operations comprising:
processing an unlock webpage request for a user interface for unlocking or unfreezing data about a user, the unlock webpage request being sent based on a third-party web server receiving an application request on a third-party website hosted by the third-party web server, the processing comprising storing information about the user in a cache based on determining that the data about the user is locked;
transmitting the user interface that is displayable simultaneously with at least part of the third-party website;
processing an unlock request for unlocking or unfreezing the data about the user based on information provided via the user interface, the information comprising consent to unlock or unfreeze the data about a user, the processing comprising comparing the information of the user with the cache and causing the data about the user to be unlocked or unfrozen based on the information of the user matches the cache; and
processing a data access request for accessing unlocked data about the user, the processing comprising transmitting the unlocked data based on determining that the data about the user is unlocked.

16. The non-transitory computer-readable storage medium of claim 15, wherein the information provided via the user interface further comprises a validity period of time during which the data about the user is unlocked or unfrozen, wherein the data about the user is stored in a data store and data in the data store is maintained by:
for each user having a temporary unlock associated therewith, comparing a relock time with a current timestamp; and
based on the current timestamp has passed the relock time, relocking or freezing the data for the user.

17. The non-transitory computer-readable storage medium of claim 15, wherein processing the unlock webpage request comprises:
searching a protected datastore for the data about the user;
based on the data about the user being found in the protected datastore, determining an access status of the data about the user; and
based on the access status of the data about the user being unlocked or unfrozen, transmitting an error message to the third-party web server.

18. The non-transitory computer-readable storage medium of claim 15, wherein processing the unlock request comprises authenticating the user by:
determining a risk level associated with the user; and
requesting additional information about the user based on the risk level by presenting an additional user interface requesting the additional information.

19. The non-transitory computer-readable storage medium of claim 15, wherein processing the data assess request comprises:
searching a protected datastore for data about the user;
determine an access status of the data about the user;
based on determining that the access status of the data about the user is locked, searching a list of authorized third parties for the user to determine a match of an identifier of a third party associated with the third-party web server; and
based on determining that the identifier of the third party associated with the third-party web server is on the list, send unlocked data to the third-party web server.

20. The non-transitory computer-readable storage medium of claim 15, wherein the cache is cleared periodically.
